(19) United States
(12) Patent Application Publication
(10) Pub. No.: US 2007/0038787 A1
(43) Pub. Date: Feb. 15, 2007

(54) Interface device and method for networking legacy consumer electronics devices

(75) Inventors: Glen M. Harris, Auckland (NZ); Justin M. Henry, Mississauga (CA)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Logitech Europe S.A., Romanel-sur-Morges (CH)

(21) Appl. No.: 11/390,916

(22) Filed: Mar. 27, 2006

Related U.S. Application Data
(60) Provisional application No. 60/666,789, filed on Mar. 30, 2005.

(51) Int. Cl. G06F 13/38; G06F 13/36

(52) U.S. Cl. 710/72; 710/315

(57) ABSTRACT

A novel device and method for connecting devices which are not inherently compliant with a network to such a network, includes a network interface controller, to connect the interface device to the network, a transmitter capable of transmitting control signals to the device, a microprocessor and a non volatile memory. The microprocessor creates and maintains a representation of the state of the device in the non volatile memory. In response to commands to alter the state of the device, received from the network, the microprocessor transmits the appropriate commands to the device and updates the stored representation of the state of the device accordingly. In response to requests for information regarding the state of the device, received from the network, the microprocessor forms an appropriate reply based upon the information in the stored representation of the state of the device. If required by the network, the interface device can perform discovery and description functions as a proxy for the device.

### CROSS-REFERENCES TO RELATED APPLICATIONS

NOT APPLICABLE

### STATEMENT AS TO RIGHTS TO INVENTIONS MADE UNDER FEDERALLY SPONSORED RESEARCH AND DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK

NOT APPLICABLE

### BACKGROUND OF THE INVENTION

The present invention relates to a device and method for connecting devices to a network. More specifically, the present invention relates to a device and method for interfacing legacy consumer electronics devices, or the like, to consumer electronics networks such as home media networks.

Much interest has been generated recently in establishing consumer electronics networks for consumer electronic devices and the like. In particular, much work is being pursued to establish networks for media, such as television, video and audio in the home. Ideally, such consumer electronics networks will allow media devices connected to the network to communicate with and/or be controlled by other devices on the network. Functionalities such as automated recording and playback of favorite television programs and/or streaming of prerecorded media from “juke box” servers to players in various parts of the home are contemplated. Further, other household systems can also be connected to such consumer electronics networks allowing, for example, room lighting to be dimmed for viewing videos, etc.

While interest in such networks is high, manufacturers have realized that such networks must be easy to use, setup and add devices to or few consumers will adopt them. Accordingly, consumer electronics manufacturers and others have proposed various network protocols to implement such networks. Examples of such network protocols include the Universal Plug and Play (UPnP) protocol, originally proposed by Microsoft, and the Home Audio Video Interoperability (HAVi), protocol proposed by a group of consumer electronics manufacturers.

One of the principle features of such networks is the intended ease with which devices can be added to the network or removed from the network. Ideally, the network protocol includes a defined set of inherent configuration features (such as the discovery and description functions of UPnP) so that a consumer need only attach (or detach) a new device to the network and the new device and the devices already on the network will automatically configure themselves to interoperate with the new device.

Unfortunately, to use such networks consumers must replace their non-compliant (legacy) consumer electronics devices which were manufactured without support for such networks, as such non-compliant devices will not operate with the networks. As replacing these non-compliant devices can involve a significant expense, consumers may hesitate or avoid adopting the new networks. Further, compliant equivalents for some non-compliant devices may not be available when desired by the consumer, as devices are introduced over time, or may never be available if they are unusual devices or there is not sufficient demand for them.

It is desired to be able to include devices in consumer electronics networks, which devices are not inherently compliant with such networks.

### BRIEF SUMMARY OF THE INVENTION

It is an object of the present invention to provide a novel interface device and method for networking consumer electronics devices which obviates or mitigates at least one disadvantage of the prior art.

According to a first aspect of the present invention, there is provided an interface device to connect a device which is not inherently compliant with a network standard to such a network, comprising: a network interface controller to connect the interface device to the network; a non volatile memory; a control signal transmitter to transmit control signals to the device; and a microprocessor connected to the network interface controller to receive and transmit information on the network, the microprocessor also being connected to the non volatile memory and operable to store a representation of the state of the device in the non volatile memory, the microprocessor also being connected to the control signal transmitter to transmit commands to the device and the microprocessor being responsive to information received on the network to cause the control signal transmitter to transmit control signals to the device to alter the state of the device and the microprocessor being operable to update the stored representation of the state of the device to correspond with the altered state of the device.

Preferably, the microprocessor is further operable to provide discovery and description functions and information for the device to the network. Also preferably, the microprocessor is further operable to reply to requests from the network for information relating to the state of the device with the corresponding information in the stored representation of the state of the device.

According to another aspect of the present invention, there is provided a method of interfacing a device which is not inherently compliant with a network standard to such a network, comprising the steps of: (i) determining the possible states of the device to be interfaced and the control signals which can be used to move between those states; (ii) creating a representation of the state of the device; (iii) receiving a request from the network to alter the state of the device; (iv) determining at least one appropriate command for the device to appropriately alter its state; (v) transmitting the at least one appropriate command to the device to alter its state to a new state; and (vi) updating the representation of the state of the device to correspond to the new state.

The present invention provides a novel device and method for connecting devices which are not inherently compliant with a network to such a network. In particular, the interface device creates and maintains a representation of the state of the device and uses this stored representation to provide information about the state of the device in response to requests for such information from the network.

### BRIEF DESCRIPTION OF THE DRAWINGS

Preferred embodiments of the present invention will now be described, by way of example only, with reference to the attached Figures, wherein:

FIG. 1 shows a schematic representation of an interface device in accordance with the present invention;

FIG. 2 shows another embodiment of the interface device of FIG. 1;

FIG. 3 shows another embodiment of the interface device of FIG. 1;

FIG. 4 shows another embodiment of the interface device of FIG. 1; and

FIG. 5 shows another embodiment of the interface device of FIG. 1.

### DETAILED DESCRIPTION OF THE INVENTION

As used herein, the term “legacy device” is intended to comprise any device which is not inherently compliant with the network to which it is desired to connect the device. In many cases, such legacy devices are only able to receive control signals from a controller, such as an infrared remote control, and cannot communicate back to the controller. Consumer electronics networks, such as UPnP or HAVi, require a bi-directional communications link to the devices to be controlled and, accordingly, it is not presently possible to use such consumer electronics networks to directly control many legacy devices. In other cases, the legacy device may have been manufactured for use with a network of a type other than the type of the network to which it is desired to connect the device, or the legacy device may implement an earlier (not backward compatible) version of the network standard, etc. In such cases it is also not possible to use such consumer electronics networks to directly control such legacy devices.

Examples of legacy devices can include, without limitation, television sets equipped with infrared remote controls, stereo systems equipped with infrared remote controls, air conditioner units equipped with infrared or ultrasonic remotes, etc.

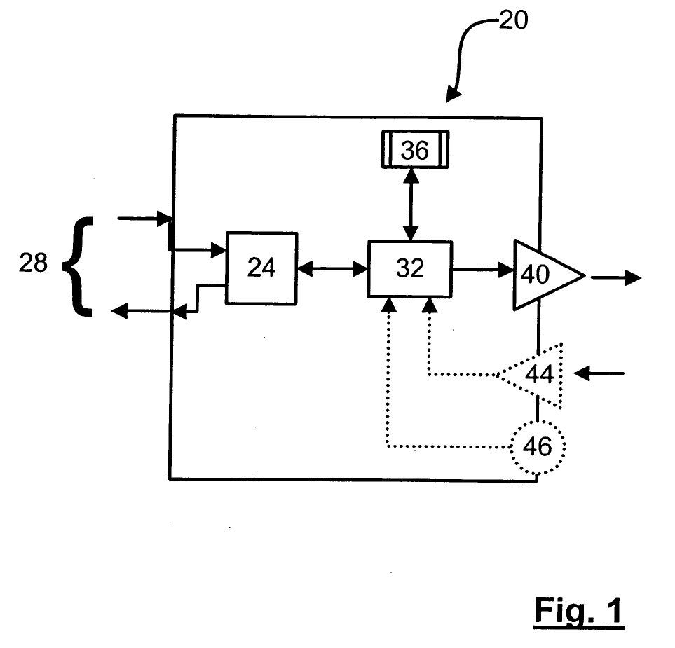

An interface device for connecting legacy devices to consumer electronics networks, in accordance with the present invention, is indicated generally at 20 in FIG. 1. Interface device 20 includes a network interface controller 24 which is operable to interface electrically and logically with a network 28, which preferably is a consumer electronics network, such as UPnP or HAVi or the like.

If network 28 is a proprietary network, or otherwise employs non-standard physical or transport protocols, network interface controller (NIC) 24 can comprise purpose built electronic interface circuitry and/or a microprocessor executing a firmware program to provide the necessary functionality for network 28. However, to date consumer electronics devices are typically connected to networks such as UPnP and HAVi which are implemented over standard physical network layers, such as Firewire (IEEE 1394), WiFi (IEEE 802.11x) or wired Ethernet and employ standard transport protocols such as UDP/IP or TCP/IP. Accordingly, for cost and/or convenience, it is preferred that network 28 be implemented with such standards so that network interface controller 24 can be a standard “off the shelf” NIC for such standard networks.

Interface device 20 further includes a microprocessor 32 which is connected to network interface controller 24 and which is operable to receive, process and reply to command or other messages over network 28 via network interface controller 24. Microprocessor 24 can be any suitable microprocessor or microcontroller, as will occur to those of skill in the art. If device 20 is to be powered by battery, as discussed below, it is preferred that microprocessor 24 be of a low power consumption design.

Microprocessor 32 is connected to a non volatile RAM 36 to store configuration data and/or state data from the consumer electronic device being controlled by interface device 20, as described below in more detail. RAM 36 can be an integral part of microprocessor 32, or can be a separate device connected to processor 32 via an appropriate bus and RAM 36 can be any form of non-volatile RAM including battery backed-up static RAM, Flash ROM, etc.

Microprocessor 32 is further connected to a control signal transmitter 40 which is operable to transmit control signals to consumer electronics devices to be controlled via network 28. It is contemplated that control signal transmitter 40 will most commonly be an infrared (“IR”) transmitter which is operable to transmit appropriate control signals, via infrared, to legacy consumer electronic devices. However, the present invention is not limited to the transmission of infrared control signals to the devices to be controlled and other transmission modalities, such as radio (RF) or acoustic (ultrasonic), can be employed instead of infrared signals. It is also contemplated that interface device 20 can include more than one control transmitter 40, each of which can employ a different transmission modality.

Interface device 20 can also optionally include one or more control signal receivers 44, each of which is operable to receive control signals transmitted to legacy devices from their associated remote controller units, as described in more detail below.

Interface device 20 can be powered via any appropriate means, as will occur to those of skill in the art. For example, if network 28 is a Firewire network, interface device 20 can be powered by the connection to network 28 as the Firewire standard permits such connections. Interface device 20 can also be powered by batteries (not shown), a combination of solar cell and batteries, AC mains supply or any other suitable power source, as will occur to those of skill in the art.

Interface device 20 can also include one or more other sensors 46, such as temperature or light level sensors to provide additional functionality. For example, if interface device 20 is used to connect a legacy air conditioning unit to network 28, then interface device 20 can include a temperature sensor which can provide network 28 with a measure of the temperature adjacent sensor 46, which is presumably located near the legacy air conditioning unit. Similarly, if interface device 20 is used to connect a legacy lighting control system to network 28, interface device 20 can include one or more light sensors which can provide network 28 with a measure of the light levels adjacent sensor 46.

It is contemplated that sensors 46 can be included in interface device 20 or, if desired, can be located some distance from interface device 20 and connected thereto by a wired or by a wireless connection. For example, sensor 46 can include an IR transmitter which transmits the sensed data to an IR control signal receiver 44 in interface device 20, or sensor 46 can include a radio transmitter, such as a Bluetooth transmitter, which transmits the sensed data to a Bluetooth control signal receiver 44 in interface device 20. As will be apparent, the above-mentioned temperature and light sensors are only examples of sensors 46 which can be employed with interface 20 and many other sensor types can be employed with interface device 20 as will occur to those of skill in the art. Similarly, the above-mentioned Bluetooth and IR links between sensors 46 and interface device 20 are only examples of possible connections to sensors 46 and many other connection types can be employed with interface device 20 such as wired USB connections, etc. as will occur to those of skill in the art.

Interface device 20 provides a method to connect legacy devices to consumer electronics networks. Interface device 20 maintains a representation of the state of the consumer electronics device being controlled via interface device 20. As used herein, the term “state” is intended to comprise an appropriate description of the operating configuration of the consumer electronics device. For example, the state of a television device can include the power status (On or Off) of the device, the channel the device is tuned to, the input it is using (DVD, Tuner, VCR), whether Picture in Picture has been activated, etc.

U.S. Pat. No. 6,784,805 to Harris et al., assigned to the assignee of the present invention, teaches a remote control for legacy devices which stores a representation of the state of the device(s) being controlled and the contents of this patent are incorporated herein by reference. In a manner similar to that taught in Harris, interface device 20, maintains a state representation for devices it is controlling. Specifically, a representation of the state of the legacy device is stored in RAM 36 and is formed by placing the consumer electronics device into a known state, such as powered off, and then updating the state representation stored in RAM 36 appropriately, as each command signal is transmitted from control transmitter 40 to the consumer electronics device.

Provided that the state of the consumer electronics device is only changed via control transmitter 40 of interface device 20, the state representation in RAM 36 will be an accurate representation of the state of the legacy device. If interface device 20 is optionally equipped with control signal receiver 44 which can receive control signals sent to the consumer electronics device from other controllers, such as a legacy IR remote control, then such a legacy IR remote control can also be employed to control the legacy device in a conventional manner, provided that control signal receiver 44 can also receive the signals transmitted from the conventional controller to the legacy device. In this case, interface device 20 will use the signals received from the legacy IR remote control to appropriately update its representation of the state of the legacy device.

For example, if a user employs the legacy IR remote control for a television set to change the channel of that set, control signal receiver 44 can also receive the IR command to change the channel and interface device 20 can then update the representation of the state of the television in RAM 36 to reflect the new channel the television is tuned to.

As will be apparent, it is possible that the state representation in RAM 36 can differ from the actual state of the legacy device and appropriate means can be employed to resynchronize the actual state of the legacy device and the representation of the state of the legacy device stored in RAM 36. For example, the user can place the legacy device into a predefined known state (such as set to channel two and powered off, etc.) and then reset interface device 20 by activating a reset switch (not shown) on interface device 20. When reset, interface device 20 can reconstruct an appropriate corresponding default representation of the state of the legacy device to resynchronize with the actual state of the legacy device.

More preferably, an interactive device, such as a personal computer also attached to network 28, can display interactive prompts, created by microprocessor 32 and forwarded to the interactive device over network 28, and the user can provide input through the interactive device to be forwarded back to microprocessor 32 in interface device 20. For example, a prompt such as “is the television set on? (Y/N)” can be shown to the user and the user can use the interactive device to reply “Y” or “N” as appropriate, to resynchronize the stored representation of the state of the legacy device with the actual state of the legacy device.

As will be apparent, to control and to construct and maintain a representation of the state of a legacy device, interface device 20 must know the signals of the command set, for transmission by control signal transmitter 40, which the legacy device can understand and the capabilities and features of the legacy device. Preferably, interface device 20 can be provided with such information via network 28 which, in turn, obtains such information from a previously established database. Such a database can be available to interface device 20 via a connection to the internet, in which case interface device 20 must be able to connect to the internet via an appropriate network connection, such as a direction connection or a connection through another device on network 28, or from a CD ROM or other mass storage device which is connected to network 28, or via any other suitable means, as will occur to those of skill in the art. Alternatively, provided that interface device 20 is equipped with optional control signal receiver 44, interface device 20 can “learn” the characteristics of a legacy device in manner similar to that described in the above-mentioned Harris et al. patent and/or the method employed with conventional trainable remotes. In such a case, the learning process can be simplified if an interactive device, such as a personal computer, which is connected to network 20, is used to prompt the user and receive the user's responses as to the type of legacy device (i.e., television, surround sound system, CD player, DVD player, Air Conditioner, etc.), the capabilities of the device (i.e., multi-disc player, Television with Picture in Picture, etc.) and to prompt the user to active the appropriate commands of the legacy remote for capture by control signal receiver 44.

It is also contemplated that, if interface device 20 does not have optional control signal receiver 44, legacy devices can still be learned, provided that another device connected to network 28 does have such a receiver and can be used to capture the legacy commands from the legacy controller. In particular, it is contemplated that if one interface device 20 on a network 28 has optional control signal receiver 44, it can be used to capture legacy commands and forward them to another interface device 20 on network 28 which will control the legacy device being learned.

Thus, as part of the set up and configuration of an interface device 20, microprocessor 32 is provided with the necessary information such that it can construct and maintain a representation of the state of the legacy device and such that it can transmit valid commands, via control signal transmitter 40, to the legacy device.

Once interface device 20 has been set up such that it knows the legacy device it is controlling, interface device 20 can perform the “discovery” and “description” functions, or their equivalents, required by the consumer electronics network 28 for devices connected thereto and can respond appropriately to commands from network 28. Effectively, interface device 20 acts as a bi-directional communication proxy for the legacy device, even if the legacy device in fact only features a uni-directional command system (e.g., an IR receiver).

Commands sent via network 28 to the legacy device are interpreted by interface device 20. If the received commands require a response, interface device 20 can respond on network 28 appropriately, referring if necessary to the representation of the state of the legacy device stored in RAM 36. For example, network 28 may query whether the legacy device is presently turned on and interface device 20 will check the representation of state stored in RAM 36 and will formulate and transmit an appropriate reply on network 28.

If network 28 sends a command to change the state of the legacy device, for example to turn the television on and change it to a particular channel, interface device 20 will determine which commands need to be transmitted from control signal transmitter 40 to effect the necessary state change (referring if necessary to the representation of the state of the legacy device in RAM 36) and will transmit those necessary commands to the legacy device from control signal transmitter 40, will update the stored representation of the state of the legacy device in RAM 36 and will transmit any required confirmation or acknowledgement signal back to network 28.

Interface device 20 can further enhance the operation of a legacy device by providing emulation for commands which are not natively available to the legacy device. For example, a legacy television may not have a native command allowing a channel to be directly tuned (i.e., jump to channel twenty seven) and may instead only provide “channel up” and “channel down” commands. Interface device 20 can include in the stored representation of state in RAM 36 the channel the television is presently tuned to. If network 28 sends a command to interface device 20 to change the selected channel from twenty two to twenty seven, for example, interface device 20 can determine a strategy to tune in the selected channel, by transmitting the appropriate number of either channel up or channel down commands to change the presently selected channel on the television to the requested channel. In this particular example, interface device could send five “up channel” commands with any necessary delays between the transmission of each command.

Preferably, when interface device 20 is first connected to network 20 it performs native discovery and description functions, or their equivalent, to announce its native presence to devices on network 28. These native functions establish the necessary parameters for interface device 20 to be configured to learn the legacy device it is to control, with the assistance of another interactive device connected to network 28 and/or with access to a database of legacy device configurations via a mass storage device connected to network 28, or via a connection to a remote database via the Internet or the like. Once interface device 20 has been configured with the characteristics of the legacy device and its representation of the state of the controlled legacy device has been established, interface device 20 can re-perform the discovery and description functions for network 28 to identify itself as a compliant version of the legacy device. It is contemplated that this identification as a compliant version of the legacy device will be in addition to its identification as its native self so that a network 28 can directly access interface device 20 to reset it, or to otherwise send it commands which interface device 20 can natively process.

While in the discussion above interface device 20 has only controlled a single legacy device, it will be appreciated that the present invention is not so limited and interface device 20 can in fact control two or more legacy devices. In such a case, RAM 36 need have sufficient capacity to store a representation of the state of each legacy device to be controlled. Also either control signal transmitter 40 must be able to generate control signals appropriate for each legacy device to be controlled, or additional control signal transmitters 40 must be provided, each being capable of transmitting appropriate control signals to at least one of the legacy devices to be controlled.

In such an embodiment, wherein interface device 20 is used to control two or more legacy devices, interface device 20 will provide discovery and description functions to network 28 for each legacy device to be controlled.

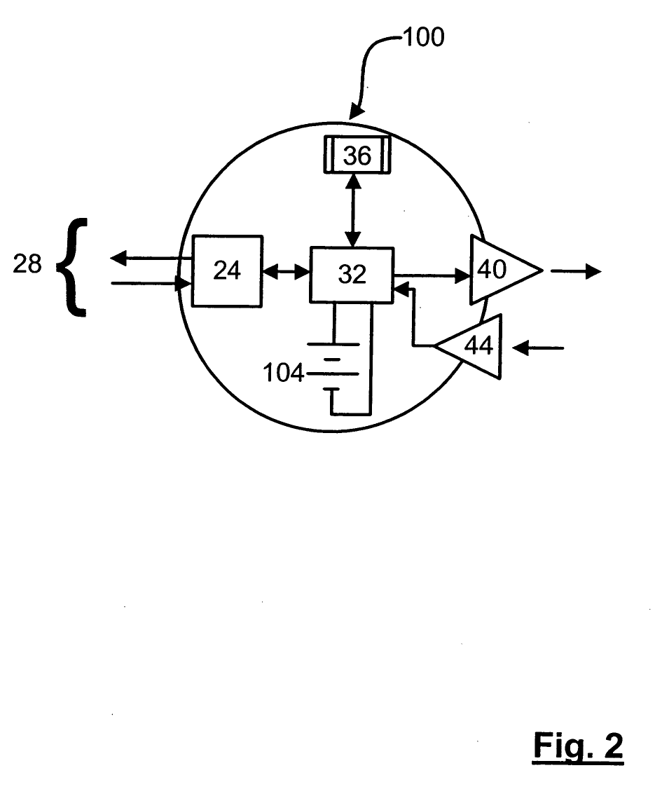

In FIGS. 2 through 5, discussed below, elements which are substantially the same in operation and/or function as elements in FIG. 1 are identified with the same reference numbers as those used in FIG. 1.

In a presently preferred embodiment, shown in FIG. 2, interface device 20 is implemented as a small device 100, which can be mounted on or near a legacy device to be controlled, such that signals from control signal transmitter 40 can be received by the legacy device. In the illustrated configuration, interface device 20 is powered by battery 104 and is preferably designed and constructed to provide a reasonable battery life and the connection of interface device 20 to network 28 is preferably achieved by a wired connection. It is contemplated that interface device 100 can be in the form of a disc, or the like, and can have control signal transmitter 40 on one side of the disc and control signal receiver 44 on the opposite side. Device 100 can be attached, adhesively or otherwise, to the IR receiver window of the legacy device to be controlled with control signal transmitter 40 facing the IR receiver window and control signal receiver 44 facing the opposite direction. In such a configuration, interface device 100 will function as described above and will also be operative to “pass through” control signals received from a legacy control device such as an IR remote control by receiving, via control signal receiver 44, and repeating, via control signal transmitter 40, those control signals. As will be apparent, as device “passes through” control signals from a legacy controller, the representation of the state of the legacy device stored in RAM 36 is appropriately updated.

Device 100 is believed to be particularly advantageous, in terms of function and cost, for use with legacy IR-based devices such as television sets or the like as it allows for the television to be a compliant component on network 28 while also allowing a user to control the legacy device in a conventional manner.

If the particular implementation of network 28 provides for attached devices to be powered by the network, such as with a Firewire network, battery 104 can be omitted from device 100 which can be powered by network 28.

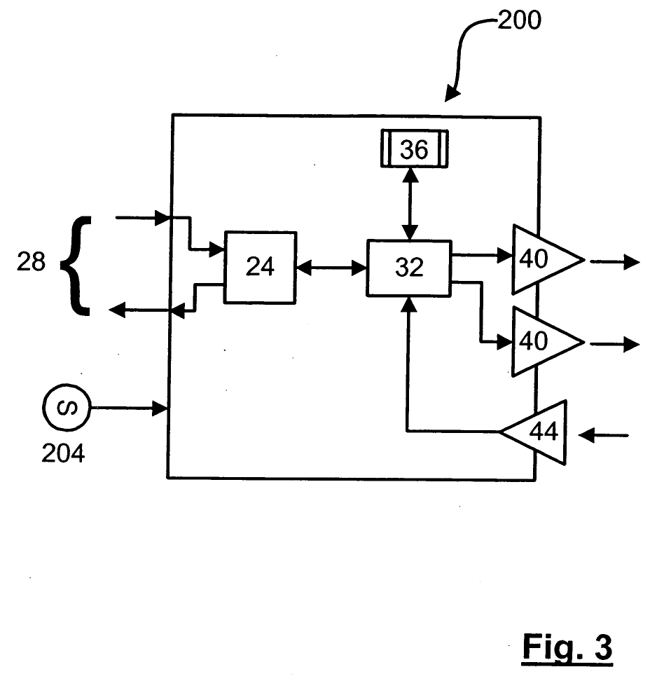

In another presently preferred embodiment shown in FIG. 3, interface device 20 is implemented as an AC powered device 200 connected to an AC supply 204. Device 200 is preferably positioned such that signals from the one of the at least one control signal transmitters 40 can be received by the legacy device, or devices, to be controlled. As power conservation is not an issue for device 204, connection of device 200 to network 28 can be achieved in a wide variety of manners, including wireless connections (such as WiFi), AC power data connections, etc. It is contemplated that, for example, this embodiment of interface device 20 can be placed on an end table or coffee table adjacent a home theatre system and can be used to control all of the legacy devices in the home theatre system.

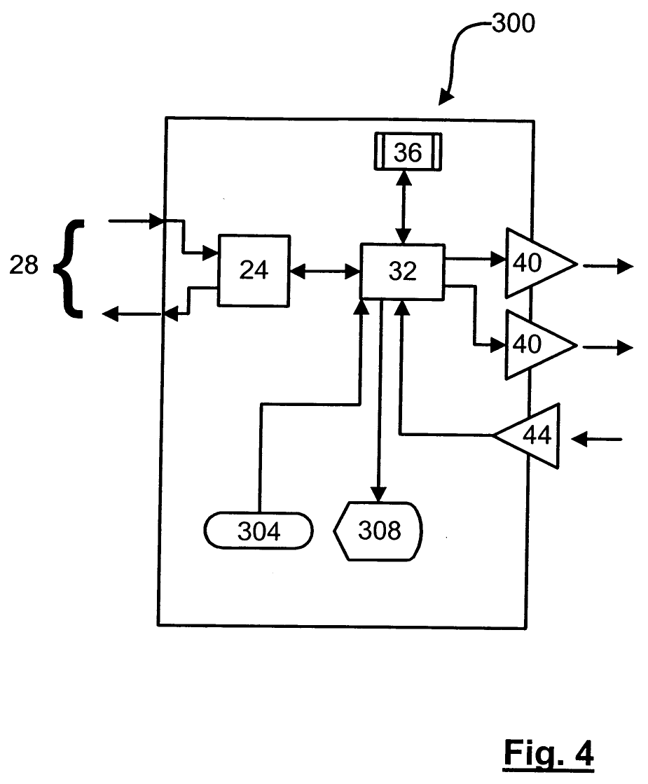

In yet another embodiment of the present invention illustrated in FIG. 4, interface device is implemented as an interactive device 300 on network 28. As shown, in addition to the components discussed above, device 300 includes a keypad 304 and a display 308, such as an LCD panel. Keypad 304 and display 308 allow a user to configure and/or interact with device 300 to, for example, configure device 300 for the legacy devices it is to interface. Further, keypad 304 and display 308 can allow a user to interact with other devices connected to network 28 and can provide desired information, such as television listings, room temperature, etc. to a user.

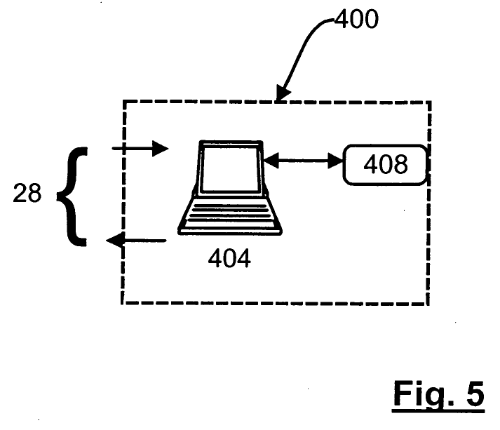

While the embodiments described above have illustrated interface device 20 as a unitary device, it is also contemplated by the present inventors that interface device 20 can be obtained as a composite of an existing device on network 28 executing appropriate software and an add-on device to that existing device. In particular, FIG. 5 illustrates a composite device 400 including a general purpose computing device 404, such as a personal computer, which is a compliant device on network 28. An add-on hardware device 408 is connected to computing device 404 and includes at least one control signal transmitter 40 and, preferably, at least one control signal receiver 44. Computing device 404 includes a microprocessor or the like which performs the functions of microprocessor 32 and includes RAM memory and non-volatile storage, such as a disc drive or Flash ROM, which can be used to store a representation of the state of each legacy device to be interfaced by device 400. Add-on hardware device 408 can be in suitable form, such as a USB “dongle” or the like.

If a computing device, such as general purpose computing device 404 is present on network 28, composite device 400 provides many advantages including a greatly reduced cost, as it is only necessary to provide appropriate software to general purpose computing device 404 and add-on device 408, which can be relatively inexpensive to manufacture due to its simplicity. In addition, the computing resources typically present in general purpose computing devices, such as personal computers, are typically much greater than those which could cost-effectively be provided in the other embodiments of device 20 described above, allowing for enhanced functionality to be provided by composite device 400. Such enhanced functionality can include, without limitation: timed functions, i.e., sending desired control signals to legacy devices at pre-selected times o activating a legacy device for a selected duration of time, etc.; adaptive functions, i.e., activating a legacy air conditioner when a sensed temperature is exceeded, or turning on a room lighting system when a person enters a room, or turning on a legacy television set to a channel previously being watched by a user in another room when the user enters that room and turning off the legacy television in that other room which is no longer being watched; etc.

The present invention provides a novel device and method for connecting devices which are not inherently compliant with a network to such a network. In particular, the interface device creates and maintains a representation of the state of the device and uses this stored representation to provide information about the state of the device in response to requests for such information from the network. The device can provide enhanced commands which are not inherently supported by the device.

The above-described embodiments of the invention are intended to be examples of the present invention and alterations and modifications may be effected thereto, by those of skill in the art, without departing from the scope of the invention which is defined solely by the claims appended hereto.

What is claimed is:

1. An interface device to connect a device which is not inherently compliant with a network standard to such a network, comprising:
a network interface controller to connect the interface device to the network;
a non volatile memory;
a control signal transmitter to transmit control signals to the device; and
a microprocessor connected to the network interface controller to receive and transmit information on the network, the microprocessor also being connected to the non volatile memory and operable to store a representation of the state of the device in the non volatile memory, the microprocessor also being connected to the control signal transmitter to transmit commands to the device and the microprocessor being responsive to information received on the network to cause the control signal transmitter to transmit control signals to the device to alter the state of the device and the microprocessor being operable to update the stored representation of the state of the device to correspond with the altered state of the device.

2. The interface device of claim 1 further including a control signal receiver operable to receive control signals transmitted to alter the state of the device, the microprocessor also being responsive to the control signals for the device received by the control signal receiver to alter the stored representation of the state of the device to correspond to the altered state of the device.

3. The interface device of claim 1 wherein the microprocessor is further operable to provide discovery and description functions and information to the network as a proxy for the device.

4. The interface device of claim 1 wherein the microprocessor is further operable to reply to requests from the network for information relating to the state of the device with the corresponding information in the stored representation of the state of the device.

5. The interface device of claim 1 further including at least one sensor to obtain data relevant to the operation of the device and wherein the microprocessor is further operable to provide the obtained data to the network.

6. The interface device of claim 1 wherein the interface device is powered by a battery.

7. The interface device of claim 1 wherein the interface device is powered by the network.

8. The interface device of claim 1 wherein the interface device is connected to the network by a wireless link.

9. The interface device of claim 8 wherein the wireless link is a radio link.

10. A method of interfacing a device which is not inherently compliant with a network standard to such a network, comprising the steps of:
(i) determining the possible states of the device to be interfaced and the control signals which can be used to move between those states;
(ii) creating a representation of the state of the device;
(iii) receiving a request from the network to alter the state of the device;
(iv) determining at least one appropriate command for the device to appropriately alter its state;
(v) transmitting the at least one appropriate command to the device to alter its state to a new state; and
(vi) updating the representation of the state of the device to correspond to the new state.
